(19) United States
(12) Patent Application Publication
(10) Pub. No.: US 2023/0093415 A1
(43) Pub. Date: Mar. 23, 2023

(54) METHOD OF MANUFACTURING AN ELECTRICALLY INSULATED CONDUCTOR

(71) Applicant: SAMSUNG SDI CO., LTD., Yongin-si (KR)

(72) Inventors: Wolfgang Reinprecht, Attendorf (AT); Fritz Haring, Bruck an der Mur (AT); Mariagrazia MONTARULI, Graz (AT)

(21) Appl. No.: 17/949,108

(22) Filed: Sep. 20, 2022

(30) Foreign Application Priority Data
Sep. 21, 2021 (EP) 21198000.8
Sep. 19, 2022 (KR) 10-2022-0118200

(51) Int. Cl. H01B 13/10; H01B 3/08; H01M 50/502

(52) U.S. Cl. CPC H01B 13/10; H01B 3/084; H01M 50/502; H01M 2220/20

(57) ABSTRACT

A method of manufacturing an electrically insulated conductor for a battery system includes: covering a circumference of an electrical conductor with at least one fiber mat electrically insulating cover portion; and welding end portions of the fiber mat electrically insulating cover portion to form a closed insulating sleeve around the circumference of the electrical conductor.

### CROSS-REFERENCE TO RELATED APPLICATION

This application claims priority to and the benefit of European Patent Application No. 21198000.8, filed in the European Patent Office on Sep. 21, 2021, and Korean Patent Application No. 10-2022-0118200, filed in the Korean Intellectual Property Office on Sep. 19, 2022, the entire content of both of which are incorporated herein by reference.

### BACKGROUND

### 1. Field

Aspects of embodiments of the present disclosure relate to a method of manufacturing an electrically insulated conductor.

### 2. Description of the Related Art

Recently, vehicles for transportation of goods and peoples have been developed that use electric power as a source for motion. Such an electric vehicle is an automobile that is propelled by an electric motor using energy stored in rechargeable batteries. An electric vehicle may be solely powered by batteries or may be a hybrid vehicle powered by, for example, a gasoline generator or a hydrogen fuel power cell. A hybrid vehicle may include a combination of electric motor and conventional combustion engine. Generally, an electric-vehicle battery (EVB or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supplies for small electronic devices, such as cellular phones, notebook computers, and camcorders, while high-capacity rechargeable batteries are used as power supplies for electric and hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, such as cylindrical or rectangular, may be selected based on the battery's intended purpose. Lithium-ion (and similar lithium polymer) batteries, widely known via their use in laptops and consumer electronics, dominate the most recent electric vehicles in development.

Rechargeable batteries may be used as a battery module formed of a plurality of unit battery cells coupled together in series and/or in parallel to provide a high energy content, such as for motor driving of a hybrid vehicle. The battery module may be formed by interconnecting the electrode terminals of the plurality of unit battery cells in a manner depending on a desired amount of power and to realize a high-power rechargeable battery.

Battery modules can be constructed either in a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage. The battery modules may include submodules with a plurality of stacked battery cells, and each stack includes cells connected in parallel that are, in turn, connected in series (XpYs) or cells connected in series that are, in turn, connected in parallel (XsYp).

A battery pack is a set of any number of (usually identical) battery modules. The battery modules may be configured in series, parallel, or a mixture of both to deliver the desired voltage, capacity, and/or power density. Components of a battery pack include the individual battery modules and the interconnects, which provide electrical conductivity between the battery modules.

Static control of battery power output and charging may not be sufficient to meet the dynamic power demands of various electrical consumers connected to the battery system. Thus, steady exchange of information between the battery system and the controllers of the electrical consumers may be employed. This information may include the battery system's actual state of charge (SoC), potential electrical performance, charging ability, and internal resistance as well as actual or predicted power demands or surpluses of the consumers.

Battery systems may also include a battery management system (BMS) and/or a battery management unit (BMU) for processing the aforementioned information. The BMS/BMU may communicate with the controllers of the various electrical consumers via a suitable communication bus, such as a SPI or CAN interface. The BMS/BMU may further communicate with each of the battery submodules, such as with a cell supervision circuit (CSC) of each battery submodule. The CSC may be further connected to a cell connection and sensing unit (CCU) of a battery submodule that interconnects the battery cells of the battery submodule.

The BMS/BMU is provided to manage the battery pack, such as by protecting the battery from operating outside its safe operating area (or safe operating parameters), monitoring its state, calculating secondary data, reporting that data, controlling its environment, authenticating it, and/or balancing it.

A thermal management system may be used to provide thermal control of the battery pack to safely use the battery module by efficiently emitting, discharging and/or dissipating heat generated from its rechargeable batteries. If the heat emission/discharge/dissipation is not sufficiently performed, temperature deviations may occur between respective battery cells, such that the battery module may no longer generate a desired amount of power. In addition, an increase of the internal temperature can lead to abnormal reactions occurring in the battery cells, and thus, charging and discharging performance of the rechargeable batteries deteriorates and the life-span of the rechargeable batteries is shortened.

Battery systems and battery packs need to withstand high temperatures. For example, in a thermal propagation event of the battery cells, the temperature can rise quickly to temperature levels that cannot be managed. For example, in a thermal runaway event, hot venting gases may be released by the battery cells.

In battery systems according to the related art, electrical insulators of bus bars or high voltage (HV) cables have rather limited temperature resistance. In the event of thermal propagation, the temperature may easily exceed the melting temperature of the electric insulators of a HV bus bar and/or HV cable, which may result in an internal short circuit followed by critical heat generation, danger for vehicle passengers, and a risk that the vehicle might even catch fire.

Glass sleeves are known insulators, but glass sleeves are difficult to produce in an industrialization process. Further, significant effort is required to install them over the cable or bus bar, and there is no chance of guaranteeing proper closure of the end sections at the terminals.

### SUMMARY

According to embodiments of the present disclosure, a method for manufacturing an electrically insulated conductor that can be manufactured more easily is provided. According to other embodiments of the present disclosure, a high temperature insulation that may withstand thermal propagation events and can be applied to various electrical conductor shapes is provided.

A method of manufacturing an electrically insulated conductor for a battery system is provided. The method includes providing an electrical conductor for conducting an electrical current and covering a circumference of the electrical conductor with at least one electrically insulating cover portion. The electrically insulating cover portion may be a fiber mat. The method further includes welding end portions of the electrically insulating cover portion to form a closed insulating sleeve around the circumference of the electrical conductor.

A fiber mat may be a mat made of (or including) a plurality of fibers. The fiber mat may be woven. The mat may be, for example, a fabric. The fibers of the fiber mat are heat-resistant fibers. The circumference (or periphery) of the electrical conductor may be spherical but can be non-spherical, such as square or rectangular. The term closed may mean continuous, endless, or gapless. For example, after the welding, the formed insulating sleeve entirely surrounds the electrical conductor (e.g., entirely surrounds a periphery or circumference of the electrical conductor). The welding may cause fibers to melt such that the end portions of the electrically insulating cover portions are melted together.

Due to the welding of the end portions of the fiber mat, an endless enclosure around the circumference is easily produced and the joining of the end portions of the fiber mat is achieved by a clean welding process. Because the fibers of the fiber mat are heat-resistant, a temperature-resistant enclosure is provided. The fiber mat can be used to surround or enclose variously-shaped electrical conductors. For example, it can be applied to HV bus bars or HV cables to withstand thermal runaway events. Thus, internal short circuits can be effectively be prevented in such situations.

The melting temperature of the fiber may be above about 1000° C., such as above about 1100° C. Upon selecting fibers for the fiber mat, the electrically insulating cover may better withstand thermal runaway events. The fibers may be one from among basalt fibers, silicate fibers, and glass fibers. Accordingly, internal short circuits can be effectively prevented.

In one embodiment, the fibers are glass fibers. The glass fibers have a melting temperature above about 1200° C. and, thus, temperature resistant insulation of the electrical conductor is provided. Further, the glass fiber remains clean after the welding process and does not store any carbon in the process. Thus, the manufactured insulation has a high degree of electrical resistance after the welding process is performed.

The method may further include wrapping the electrically insulating cover portion around the circumference of the electrical conductor. Further, the method may include welding opposite end portions of the electrically insulating cover portion to form the closed insulating sleeve around the circumference of the electrical conductor. Because the fiber mat is bendable (or flexible), the wrapping may be easily performed. The term wrapping may include folding around the electrical conductor. Therefore, a one-piece electrically insulating cover portion may be manufactured by welding the opposite ends of the one-pieced cover portion around the electrical conductor. Further, a one-piece electrically insulating cover portion may be suitable for cylindrical electrical conductors (e.g., for a cable or an electrical wire). However, a bus bar may also be sleeved (or covered) by a one-piece cover portion.

The method may include covering a first surface of the electrical conductor with a first electrically insulating cover portion and covering a second surface of the electrical conductor opposite to the first surface with a second electrically insulating cover portion. The method may include welding end portions of the first electrically insulating cover portion and respective end portions of the second electrically insulating cover portion together to form a closed insulating sleeve around the circumference of the electrical conductor. By using two cover portions, many different shapes of electrical conductors may be easily surrounded and covered by the sleeve. For example, a bus bar having a rectangular section in which opposing surfaces are flat surfaces may be covered by two cover portions that are welded together to then form the insulating sleeve across the side surfaces of the bus bar.

The welding includes increasing the temperature of the end portions of the fiber mat to be above the melting temperature of the fibers. Thus, during welding, a weld section is formed at where the fibers are melted together to form a closed junction. The junction or weld section may, thus, be a homogeneous fiber material, for example, a homogeneous glass such that a stable closure using the same base material is provided.

The welding may be performed by laser welding or arc welding. These welding techniques allow for narrow and deep localized welds. Thereby, precise and/or accurate junctions may be formed.

The fiber mat may be embedded in a resin matrix. The resin may be, for example, an epoxy resin or a phenolic resin. The resin matrix provides mechanical fixation of the fiber mat and/or the fibers. Further, during (or in) the welding process, the resin at the weld sections is burned or evaporated such that the weld section includes homogeneous fiber material after cooling, such as glass when glass fibers are used, without resin at the weld. The resin matrix also provides dust protection.

According to another embodiment of the present disclosure, an electrically insulated conductor for a battery system is provided. The electrically insulated conductor includes an electrical conductor for conducting an electrical current. The electrically insulated conductor further includes an electrically insulating cover formed around a circumference of the electrical conductor. The electrically insulating cover may be fiber mat. The electrically insulating cover forms a closed insulating sleeve around the circumference of the electrical conductor. Further, the insulation cover has at least one weld section.

The weld section may be referred to as junction of homogeneous fiber material. A fiber mat may be a mat made of (or including) a plurality of fibers. The weld section includes melted and homogenized material of the fibers as the result of locally melting/welding the fibers. Thus, when glass fibers are used, the weld section may include glass as the homogenous material. Apart (or spaced) from the weld section, the insulating cover includes (or is) the fiber mat, which may be a woven mat. The term mat may be a fabric. The fibers of the fiber mat are heat-resistant fibers. The circumference of the electrical conductor may be spherical but can be non-spherical, such as square or rectangular. The term closed may also be referred to as continuous, endless, or gapless. The electrical conductor may be a bus bar or a cable wire, such as a HV bus bar or a HV cable, which may withstand thermal runaway events.

The electrically insulated conductor can provide high temperature protection against thermal runaway and hot venting gases to prevent or mitigate electrical short circuits. It can be easily and rapidly produced and has a clean welded connection or welded joint. Further, the weld section can opened to allow access to the electrically insulated conductor for rework opportunity.

The at least one weld section may extend in a lengthwise direction of the electrical conductor. Thus, the electrical conductor may be insulated over a large part of the length or entirely over the full length of the electrical conductor.

The heat-resistant fiber may be a glass fiber. The glass fiber has high temperature resistance; for example, it has a melting temperature above about 1200° C. and, thus, is suitable to provide insulation during a thermal propagation event. The weld section may have a high degree of purity and a high degree of electrical resistance. In further embodiments, the fibers may be one from among basalt fibers, silicate, and glass fibers.

The electrically insulated conductor may have one weld section to form the closed insulating sleeve around the circumference of the electrical conductor. For example, the electrical conductor may have a circular cross section such that the electrically insulating cover forms a cylindrical sleeve around the electrical conductor. An electrically insulated conductor, such as HV cables, may be easily covered by one welding process.

The electrically insulating cover may have a first weld section and a second weld section opposite to the first weld section to form the closed insulating sleeve around the circumference of the electrical conductor. Thus, the electrically insulating cover may, due to the two weld sections, be used to cover many different shapes of electrical conductors, for example, bus bars having a rectangular cross section.

The electrically insulating cover may include flat portions opposite to each other and inclined portions connecting (or extending between) the flat portions and the weld sections. This configuration may provide a closed sleeve for a rectangular or square cross section of an electrical conductor.

The fiber mat may be embedded in a resin matrix. The resin matrix provides mechanical fixation of the fiber mat and/or the fibers. Further, in the welding process, the resin at the weld sections may be removed (e.g., burned or evaporated) due to the high temperatures, such that the weld section includes homogeneous fiber material after cooling, such as glass when glass fibers are used.

According to another embodiment of the present disclosure, a battery pack or a battery system for an electric vehicle may include an electrically insulated conductor as described above. The battery system/pack may include a plurality of battery cells connected together to provide a high voltage output. The electrically insulated conductors may be used, for example, for connecting or interconnecting battery cells.

According to another embodiment of the present disclosure, a vehicle including a battery pack or a battery system as described above is provided.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIGS. 1A and 1B illustrate a method of manufacturing an electrically insulated conductor for a battery system according to an embodiment;

FIG. 2 illustrates an electrically insulated conductor according to an embodiment;

FIG. 3 illustrates a method of manufacturing an electrically insulated conductor for a battery system according to an embodiment; and

FIG. 4 illustrates an electrically insulated conductor according to an embodiment.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. In the drawings, like reference numerals denote like elements, and redundant descriptions may be omitted. Also, in the drawings, the relative sizes of elements, layers, and regions may be exaggerated for clarity. For example, in the drawings, the size or thickness of each element may be arbitrarily shown for illustrative purposes, and thus, embodiments of the present disclosure should not be construed as being limited thereto. The present disclosure, however, may be embodied in various different forms and should not be construed as being limited to the embodiments illustrated herein. Rather, these embodiments are provided as examples so that this disclosure will be thorough and complete, and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described.

As used herein, the term “and/or” includes any and all combinations of one or more of the associated listed items. Further, the use of “may” when describing embodiments of the present disclosure refers to “one or more embodiments of the present disclosure.” In the following description of embodiments of the present disclosure, the terms of a singular form may include plural forms unless the context clearly indicates otherwise. Expressions, such as “at least one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that although the terms “first” and “second” are used to describe various elements, these elements should not be limited by these terms. These terms are only used to distinguish one element from another element. For example, a first element may be named a second element and, similarly, a second element may be named a first element, without departing from the scope of the present disclosure.

It will be further understood that the terms “have,” “include,” “comprise,” “having,” “including,” or “comprising” specify a property, a region, a fixed number, a step, a process, an element, a component, and a combination thereof but do not exclude other properties, regions, fixed numbers, steps, processes, elements, components, and combinations thereof.

It will also be understood that when a film, a region, or an element is referred to as being “above” or “on” another film, region, or element, it can be directly on the other film, region, or element, or intervening films, regions, or elements may also be present.

Herein, the terms “upper” and “lower” are defined according to the z-axis. For example, the upper cover is positioned at the upper part of the z-axis, whereas the lower cover is positioned at the lower part thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

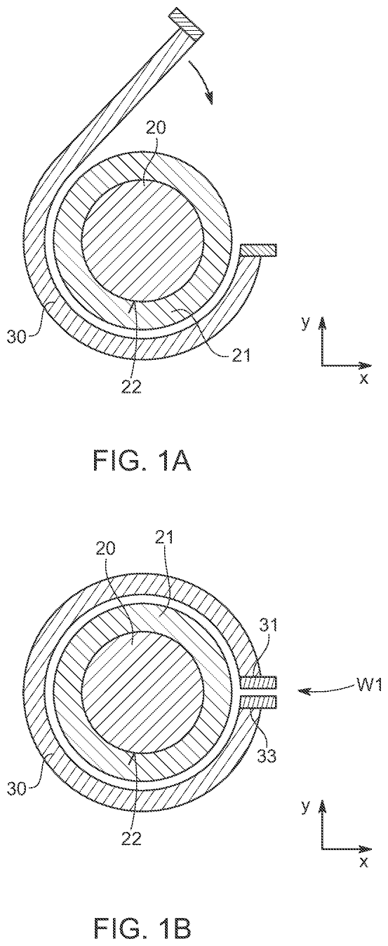

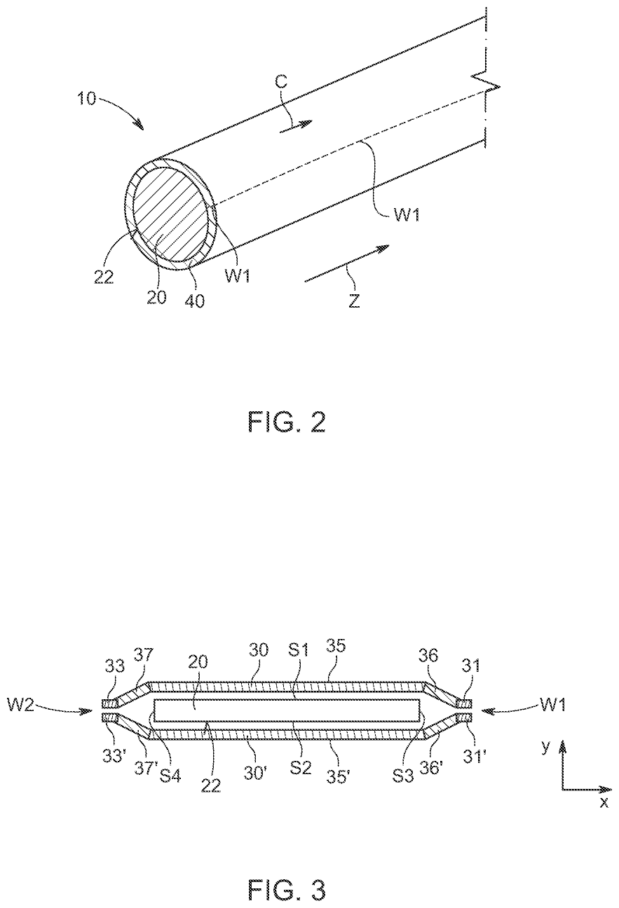

FIGS. 1A and 1B illustrate a method of manufacturing an electrically insulated conductor 10 for a battery system or a battery pack according to an embodiment, and FIG. 2 illustrates a perspective view of the electrically insulated conductor 10. The cross sectional view of FIGS. 1A and 1B spans the x-axis and the y-axis in the Figures.

The method includes providing an electrical conductor 20 for conducting an electrical current (see, e.g., FIG. 1A). In this example, the electrical conductor 20 may be a cable wire, in particular a high voltage (HV) cable wire. The electrical conductor 20 may have a cylindrical shape and may have a circular cross section as shown in, for example, FIG. 1A.

The electrical conductor 20 may include cable insulation (e.g., a cable insulator) 21 formed around the electrical conductor 20 to form an annular sleeve around the electrical conductor 20. The cable insulation 21 may provide basic insulation protection for the electrical conductor 20 by using known insulation materials during normal operation. However, in some embodiments of the present invention, the cable insulation 21 may be omitted.

The method further includes covering a circumference 22 of the electrical conductor 20 with at least one electrically insulating cover portion 30 (see, e.g., FIG. 1B). In the present disclosure, the electrically insulating cover portion 30 is a fiber mat formed by heat-resistant fibers. The size of the insulating cover portion 30 may be based on the size (e.g., a length and cross section) of the electrical conductor 20. For example, the melting temperature of the fibers may be above about 1000° C., including above about 1100° C., to withstand thermal runaway events and hot venting gases. The fibers of the fiber mat may be one from among basalt fibers, silicate fibers, and, in on embodiment, may be glass fibers. to mechanical fix the heat-resistant fibers, they may be embedded in a resin matrix, such that the mat may be reinforced. The fiber mat may be a woven mat. The same material properties may apply to other embodiments of the present disclosure described below.

In the illustrated embodiment, the covering is performed by wrapping the fiber mat around the circumference 22, in this example the cylindrical circumference, of the electrical conductor 20. In this embodiment, the electrical conductor 20 has a cylindrical cross section. The electrically insulating cover portion 30 is, in this embodiment, a single electrically insulating cover portion 30.

The method according to this embodiment further includes welding of opposite end portions 31, 33 of the electrically insulating cover portion 30. FIG. 1B shows a state just before the welding. By welding the opposite end portions 31, 33 together, the electrically insulating cover portion 30 forms a closed insulating sleeve around the circumference 22 of the electrical conductor 20. For example, the end portion 31 and the end portion 33 of the electrically insulating cover portion 30 are welded together. The welding is performed where the end portions 31, 33 of the electrically insulating cover portion 30 meet, for example, where the end portions are brought into contact as illustrated in FIG. 1B. When using glass fiber, the weld remains clean after the welding process and no carbon is stored. The end portions 31, 33 may further include protrusions 32, 34. The protrusions may provide fiber material (e.g., extra fiber material) for forming the homogeneous connection.

In the process of welding, a temperature above the melting temperature of the fibers is applied to the end portions 31, 33 of the fiber mat. Thus, the end portions 31, 33 are melted together and, after cooling the melted end portions 31, 33, a homogenized fiber material forms a weld section W1. The welding technique may be laser welding or arc welding to provide an accurate and deep welding connection.

The method uses only a single fiber mat to provide a clean closure. Further, only one welding process is needed for the wrapping process of the fiber mat. Because the electrically conductive fibers are heat resistant, a temperature-resistant enclosure is provided.

The described single electrically insulating cover portion 30 is provided for a wire cable in the illustrated embodiment. However, the single (e.g., one-piece) electrically insulating cover portion 30 may also be wrapped around a bus bar having a different cross section. The fiber mat may be flexible to be wrapped easily around the circumference of the bus bar or other conductor. To improve the wrapping (or flexibility of the wrapping), the resin matrix may be omitted.

The manufacturing method is flexible based on the shape of the electrical conductor and can be applied to, for example, HV bus bars or HV cables to withstand thermal runaway events and effectively prevent or mitigate internal short circuits.

FIG. 2 illustrates the electrically insulated conductor 10 for a battery system or battery pack manufactured according to the above-described method. The electrically insulated conductor 10 may extend in a lengthwise direction C, which coincided with the z-axis in the Figures. The electrically insulated conductor 10 may correspond to the electrically insulated conductor 10 shown in FIG. 1B as disclosed above after the welding process is finished.

An electrically insulating cover 40 is formed around the circumference 22 of the electrical conductor 20. The electrically insulating cover 40 is a fiber mat (e.g., is the electrically insulating cover portion 30) as described above. The electrically insulating cover 40 extends in a lengthwise direction C of the electrical conductor 20. Thus, the insulation of the electrical conductor 20 is performed over a length or over the entire length of the electrical conductor 20.

The electrically insulating cover 40 forms a closed insulating sleeve around the circumference 22 of the electrical conductor 20. Because the electrical conductor 20 has a circular cross section, the electrically insulating cover 40 forms a cylindrical sleeve.

The electrically insulating cover 40 has a weld section W1. In the illustrated embodiment, the weld section W1 extends in a lengthwise direction C of the electrical conductor 20. The weld section W1 forms (or is) a weld line. The weld section W1 includes homogenous material of the fibers from the fiber mat formed by the welding process, in which the fibers are melted. For example, when the fiber mat includes glass fibers, the weld section W1 may include homogeneous glass material at the weld section W1. Further, a resin matrix may be removed at the weld section W1 in response to (or due to) the high temperatures applied during the welding. Thus, the resin may be present in the fiber mat but not at the weld section W1.

A clean junction is provided at the weld section W1, which allows for rapid manufacturing as described above. The closed cover (or insulating sleeve) 40 due to the weld section W1 becomes endless and closes the electrical conductor 20 in circumferential direction.

The weld section W1 can be used for rework because it can be reopened easier compared to the fiber mat material and can be rejoined thereafter.

FIG. 3 illustrates a method of manufacturing an electrically insulated conductor 10 for a battery system or battery pack according to another embodiment. In the illustrated embodiment, an electrical conductor 20 may have a rectangular cross section. The electrical conductor 20 maybe a bus bar, such as a HV bus bar. FIG. 3 is a cross sectional view of the electrical conductor 20 that spans the x-axis and the y-axis.

As shown in FIG. 3, the method includes covering a first surface S1 of the electrical conductor 20 with a first electrically insulating cover portion 30 and covering a second surface S2 of the electrical conductor 20 opposite to the first surface S1 with a second electrically insulating cover portion 30′. The first electrically insulating cover portion 30 and the second electrically insulating cover portion 30′ may be separate cover portions, as shown in FIG. 3. The cover portions 30, 30′ may be fiber mats as described above.

The method may further include welding end portions 31, 33 of the first electrically insulating cover portion 30 with respective end portions 31′, 33′ of the second electrically insulating cover portion 30′. For example, during the welding, the fibers at the end portions 31, 33 and 31′, 33′ are melted together to form closed junctions. The junctions or weld sections may be a homogeneous fiber material (e.g., glass).

For example, the first end portion 31 of the first electrically insulating cover portion 30 is welded to the opposing first end portion 31′ of the second electrically insulating cover portion 30′. Further, the second end portion 33 of the first electrically insulating cover portion 30 is welded to the opposing second end portion 33′ of the second electrically insulating cover portion 30′.

Both electrically insulating cover portions 30, 30′ may be inclined or bent to bring respective end portions 31, 33 and 31′, 33′ of the cover portions 30, 30′ into contact with each other to perform the welding. For example, the cover portions 30, 30′ may be bent (or tilted) at their end portions 31, 33 and 31′, 33′ to form a half-shell. The cover portions 30, 30′, after tilting, may each have inclined portions 36, 36′ and 37, 37′ which are inclined with respect to flat portions 35, 35′ of the electrically insulating cover portions 30, 30′. For example, the inclined portions 36, 36′ and 37, 37′ are inclined towards the opposite electrically insulating cover portion 30, 30′, respectively. The end portions 31, 33 and 31′,33′ may, thus, overlap with the respective side surfaces S3, S4 of the electric conductor 20. The cover portions 30, 30′ may also have vertical portions which extend towards each other. The inclined portions 36, 36′ and 37, 37′ may cause less tension in the fiber mat because the tilting angle is less than orthogonal. For example the fiber mat may be embedded in a resin matrix to provide additional mechanical stiffness.

By welding the first electrically insulating cover portion 30 and the second electrically insulating cover portion 30′ at the respective end portions 31, 33 and 31′, 33′ to each other, an insulating sleeve (e.g., a fiber mat insulating sleeve) is formed around the circumference 22 of the electrical conductor 20. FIG. 3 shows a state just before the welding is performed. According to the method as described above, many different shapes of electrical conductors may be easily surrounded and covered by the fiber mat sleeves due to the use of two separated cover portions 30, 30′ that are welded together.

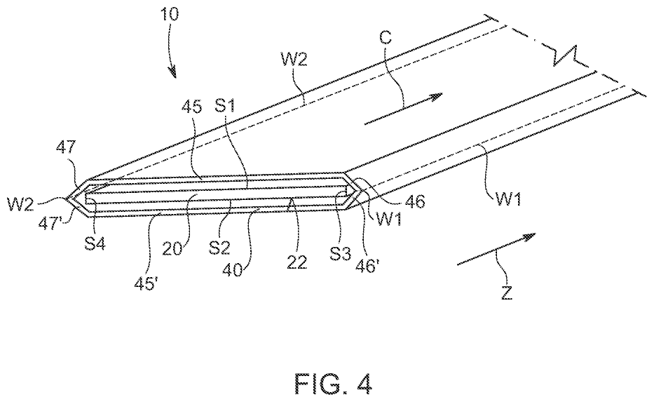

FIG. 4 illustrates an electrically insulated conductor 10 according to another embodiment in a perspective view. For example, the electrically insulated conductor 10 may extend in a lengthwise direction C that coincides with the z-axis in FIG. 4. The electrically insulated conductor 10 may be manufactured by the manufacturing process as disclosed with respect to FIG. 3 above. In the present embodiment, the electrical conductor 20 has a rectangular cross section and may be a bus bar, such as a HV bus bar for a battery system.

The electrical conductor 20 has a first surface S1 (e.g., a top surface), a second surface S2 (e.g., a bottom surface) opposite to the first surface S1, and first and second side surfaces S3, S4 connecting (or extending between) the first surface S1 and the second surface S2. The surfaces S1, S2, S3, and S4 form the circumference (or periphery) 22 of the electrical conductor 20. The electrically insulated conductor 10 includes the electrically insulating cover 40, which forms a closed insulating sleeve around the circumference 22 of the electrical conductor 20.

The electrically insulating cover 40 has a first weld section W1 and a second weld section W2 opposite to the first weld section W1. The weld sections W1, W2 both extend in the lengthwise direction C of the electrical conductor 20. Due to the first and second weld sections W1, W2, the insulating sleeve 40 is closed around the circumference 22 of the electrical conductor 20 regardless of the shape of the electrical conductor 20.

The first weld section W1 extends along the first side surface S3 of the electrical conductor 20 and overlaps with the side surface S3. The second weld section W2 extends along the second side surface S4 of the electrical conductor 20 opposite to the first side surface S3.

Further, the electrically insulating cover 40 has flat portions 45, 45′ opposite to each other. The flat portions 45, 45′ may extend parallel to the first surface S1 and the second surface S2 of the electrical conductor 20. The electrically insulating cover 40, in this embodiment, also has inclined portions 46, 46′ and 47 and 47′. The inclined portions 46, 46′ and 47, 47′ connect the flat portions 44, 44′ and the weld sections W1, W2. The inclined portions 46, 46′ and 47, 47′ are, thus, tilted (or bent) towards the opposite flat portion 44, 44′, respectively.

At the weld sections W1, W2, the electrically insulating cover 40 includes homogenized fiber material, for example, homogeneous glass to provide a clean joint and allow for rapid manufacturing for various shapes. Both weld sections W1, W2 allow for reopening for rework and may be rejoined thereafter. For example, only one of the weld sections from among the two weld sections W1, W2 may be reopened to access the electrical conductor 20.

Due to the welding of end portions of the fiber mat, an endless enclosure around the circumference of an electrical conductor is easily produced and closed by a clean weld. Because the electrically conductive fibers are heat-resistant, and may be glass fibers, a temperature-resistant enclosure is provided. The fiber mat may cover many different shapes of electrical conductor cross sections by the manufacturing methods described herein to withstand thermal runaway events and to prevent short circuits.

### SOME REFERENCE SIGNS

10 electrically insulated conductor
C lengthwise direction
20 electrical conductor
21 cable insulation
22 circumference
S1 first surface
S2 second surface
S3, S4 side surface
30, 30′ electrically insulating cover portion
31, 31′ first end portion
32, 34 protrusion
33, 33′ second end portion
35, 35′ flat portion
36, 36′ first inclined portion
37, 37′ second inclined portion
40 electrically insulating cover
45, 45′ flat portion
46, 46′ first inclined portion
47, 47′ second inclined portion
W1, W2 weld section

What is claimed is:

1. A method of manufacturing an electrically insulated conductor for a battery system, the method comprising:
covering a circumference of an electrical conductor with at least one electrically insulating cover portion, the electrically insulating cover portion being a fiber mat; and
welding end portions of the at least one electrically insulating cover portion to form a closed insulating sleeve around the circumference of the electrical conductor.

2. The method of claim 1, wherein the fiber mat comprises fibers having a melting temperature above 1000° C.

3. The method of claim 2, wherein the fibers have a melting temperature above 1100° C.

4. The method of claim 3, wherein the fibers are glass fibers.

5. The method of claim 1, further comprising:
wrapping the electrically insulating cover portion around the circumference of the electrical conductor before the welding; and
welding opposite end portions of the electrically insulating cover portion together to form the closed insulating sleeve around the circumference of the electrical conductor.

6. The method of claim 1, further comprising:
covering a first surface of the electrical conductor with a first one of the electrically insulating cover portions;
covering a second surface of the electrical conductor opposite to the first surface with a second one of the electrically insulating cover portions; and
welding end portions of the first one of the electrically insulating cover portions and respective end portions of the second one of the electrically insulating cover portions to form the closed insulating sleeve around the circumference of the electrical conductor.

7. The method of claim 1, wherein the welding comprises increasing a temperature of the end portions of the fiber mat above a melting temperature of fibers of the fiber mat.

8. The method of claim 7, wherein the welding is laser welding or arc welding.

9. The method of claim 1, wherein the fiber mat is embedded in a resin matrix.

10. An electrically insulated conductor for a battery system, the electrically insulated conductor comprising:
an electrical conductor for conducting an electrical current; and
an electrically insulating cover around a circumference of the electrical conductor, the electrically insulating cover being a fiber mat,
wherein the electrically insulating cover forms a closed insulating sleeve around the circumference of the electrical conductor and has a weld section.

11. The electrically insulated conductor according to claim 10, wherein the weld section extends in a lengthwise direction of the electrical conductor.

12. The electrically insulated conductor of claim 10, wherein the fiber mat comprises glass fibers.

13. The electrically insulated conductor according to claim 10, wherein the weld section of the electrically insulating cover forms the closed insulating sleeve around the circumference of the electrical conductor.

14. The electrically insulated conductor according to claim 10, wherein the electrically insulating cover comprises a first weld section and a second weld section opposite to the first weld section to form the closed insulating sleeve around the circumference of the electrical conductor.

15. The electrically insulated conductor according to claim 14, wherein the electrically insulating cover has flat portions opposite to each other and inclined portions respectively extending between the flat portions and the weld sections.

16. A battery system for an electric vehicle, the battery system comprising the electrically insulated conductor according to claim 10.
